(19) United States
(12) Patent Application Publication
(10) Pub. No.: US 2022/0202640 A1
(43) Pub. Date: Jun. 30, 2022

(54) Device and Method for Improved Muscle Contraction

(71) Applicant: Levante Strength Inc., Thornhill (CA)

(72) Inventor: Joshua MENEZES, Ontario (CA)

(73) Assignee: Levante Strength Inc., Thornhills, ON (CA)

(21) Appl. No.: 17/136,560

(22) Filed: Dec. 29, 2020

(51) Int. Cl. A61H 1/00; A61H 23/02

(52) U.S. Cl. CPC A61H 1/00; A61H 23/02; A61H 2201/169; A61H 2205/062; A61H 2205/081; A61H 2201/1261; A61H 2205/084; A61H 2205/086; A61H 2205/10; A61H 2201/5007; A61H 2205/083

(57) ABSTRACT

A device and a method of applying vibration on a muscle for improving muscle contraction are disclosed. The device includes a motor. The device includes an adhesive strip. The adhesive strip is a reusable dual-sided adhesive strip. The adhesive strip removably mounts over a muscle or muscle group. The motor causes vibration and transmits the vibration to the muscle through the device and the adhesive strip, causing the user to concentrate on the muscle. The user detaches the device from one muscle or muscle group, and attaches to a different muscle or muscle group. The vibration caused by the motor helps the user to concentrate on the muscle during exercise, assisting with mind-muscle connection, which helps to improve muscle contraction.

### FIELD OF INVENTION

The present subject matter generally relates to a vibratory device. More specifically, the present subject matter relates to a device that attaches with an adhesive to the skin of a user and is placed on a particular muscle or muscle group, causing the user to think about the muscle more during a workout.

### BACKGROUND OF INVENTION

Several devices exist for enhancing neurophysiological and musculophysiological performance, such as during exercise or training programs. The devices help to improve the function and recovery of muscle systems using vibration system modalities.

One such example is disclosed in a United States granted patent Publication No. 10,159,623, entitled “Wearable Vibration Device” (“the '623 Patent”). The '623 Patent discloses a novel wearable vibration device delivering high energy vibration deep into the muscles and soft tissues for muscle treatment comprising an upper soft fabric foam covered case encompassing at least a vibration motor, a lithium ion battery, a control PCB, a control switch with LED display and a lower fabric covered case. The wearable vibration device delivers high energy vibration to the chosen muscle group and thereby, penetrates deep into the muscle and to the soft tissues. The upper soft fabric foam covered case and lower fabric covered cases are fixed together by gluing or stitching. The control PCB drives the vibration motor to set frequencies for vibration motor activations. Vibrations for the device are tuned at frequencies in the range of 30-50 Hz to increase muscle power and for other beneficial physiological effects.

Another example is disclosed in a United States Patent Publication No. 20200222275, entitled “Self-aware Vibration Device” (“the '275 Publication”). The '275 Publication discloses a device for delivering a therapeutic vibration to a body. The device may include at least two motors in a housing with unbalanced masses coupled to their axles, such that vibration of the masses causes the two motors and housing to vibrate at a beat frequency. The motors and housing may be coupled to the body via a platform which places the motors and housings at or near a resonant structure in the body, creating a coupled oscillation between the platform and the body. The device may also include at least one sensor which senses at least one piece of bioinformation, the vibration may be based on the at least one piece of bioinformation.

Yet another example is disclosed in a United States Patent Publication No. 20190015046, entitled “Systems and Methods for Smart Athletic Wear” (“the '046 Publication”). The '046 Publication discloses a smart garment comprising one or more sensors contained within the smart garment and configured to gather information about a wearer of the smart garment undertaking a physical activity. The garment may also include one or more actuators contained within and configured to provide haptic feedback to the wearer of the smart garment. The one or more sensors are configured to transmit the gathered information to a processing unit within the smart garment and/or an external processor for generation of instructions to provide guidance to the wearer of the garment on how to execute the physical activity. Further, the one or more actuators can provide haptic feedback to the wearer upon receiving the instructions from the processing unit and/or the external processor.

Most of the vibration devices secure about a portion of a user's body and produce high frequency vibration. The vibration devices are held in a place lined up with the holes of an alignment strap and VELCRO® hook and loop fastener is tensioned to hold the vibration device firmly against the body. Use of straps and VELCRO take considerable time to put on and remove from the user's body. Further, straps are difficult to place over some parts of the body. Furthermore, use of straps may leave a temporary mark on the skin where they connect.

Therefore, there is a need for a device that attaches with an adhesive to the skin of a user anywhere on the body and when placed on a particular muscle or muscle group, causes the user to think about the muscle more during a workout.

The contents of all patents, patent applications, and non-patent literature cited throughout the present application are incorporated by reference in their entireties, for all purposes.

### SUMMARY

It is an object of the present subject matter to provide a device that attaches with an adhesive to the skin of a user anywhere on the body and that avoids the drawback of known techniques.

It is another object of the present subject matter to provide a device for applying vibration on a muscle or muscle group for improving muscle contraction. It should be noted that the device can work equally well by placing the device on a particular muscle or on a group of muscles, and that the terms “muscle” or “muscle group” can be used interchangeably and should not be considered limited for use on a single or particular muscle, or limited for use on muscle groups involving two or more muscles in proximity to each other. The device has a base and a top case housing a motor, an adhesive strip connecting the base. The adhesive strip removably mounts over a muscle or muscle group, wherein the motor causes vibration and transmits the vibration to the muscle through the base and the adhesive strip, and wherein the vibration causes the user to concentrate on the muscle to improve muscle contraction during a workout.

It is another object of the present subject matter to provide a device when placed on a particular muscle group causes the user to think about the muscle more during a workout.

It is another object of the present subject matter to provide a device with an adhesive (adhesive strip) that attaches and reattaches, the device that can be easily placed and moved to very specific muscles.

In order to achieve one or more objects, the present subject matter provides a device having a motor (vibration motor). The device includes an adhesive strip. The adhesive strip is a reusable and dual-sided adhesive having silicone on one side and acrylic on a second side. The device removably mounts over a muscle or muscle group via the adhesive strip. When turned ON, the motor vibrates. The vibration gets transmitted to the muscle through the device and the adhesive strip. The vibration causes the user to concentrate more on the muscle during a workout. The user detaches the device from one muscle and attaches to another muscle or muscle group with the help of the adhesive strip.

In one advantageous feature of the present disclosure, the adhesive strip allows the user to easily remove the device from one muscle and attach to another muscle or muscle group. The device is portable and attaches to any muscle with the help of the adhesive strip. This allows the device for placing anywhere on the body and provides required vibration to the user to continuously remind him or her to focus on the desired muscle.

In one advantageous feature of the present disclosure, the presently disclosed device provides portable configuration and allows for use in the gym, during training, or exercising anywhere and anytime. The portable device does not come in the way of the user performing exercise and allows the user to focus on his or her exercise. The adhesive strip allows the device to easily detach from one muscle or muscle group and attach to another. As such, the user can quickly change the location of the device to the muscle he or she wishes to strengthen and start working out without any delay between workouts. The device helps the user to work on all major muscle groups and joints, including, but not limited to, quad/hamstring, back/abdominal, arm/wrist, shoulders, and various other individual muscles, muscle groups, and joints.

It is another object to provide a method of applying vibration on a muscle or muscle group for improving muscle contraction, the method comprising providing a device having a motor, providing an adhesive strip connecting the device, attaching the adhesive strip over a first muscle, causing the motor to vibrate, transmitting the vibration from the motor to the first muscle, causing a user to concentrate on the first muscle due to the vibration for improving muscle contraction on the first muscle, contracting the first muscle, removing the device by detaching the adhesive strip of the device from the first muscle, attaching the adhesive strip of the device over a second muscle, causing the motor to vibrate, transmitting the vibration from the motor to the second muscle group, and causing the user to concentrate on the second muscle due to the vibration for improving muscle contraction on the second muscle.

It is another object of the subject matter to provide a method of applying vibration on a muscle or muscle group for improving muscle contraction, the method comprising determining a muscle of a user for exercising. The device, having a motor, is placed over the muscle using an adhesive strip. The motor is operated by the processor, to cause vibration. The motor transmits vibrations to the muscle causing the user to concentrate on the muscle for improving muscle contraction during exercise.

Features and advantages of the subject matter hereof will become more apparent in light of the following detailed description of selected embodiments, as illustrated in the accompanying FIGUREs. As will be realised, the subject matter disclosed is capable of modifications in various respects, all without departing from the scope of the subject matter. Accordingly, the drawings and the description are to be regarded as illustrative in nature.

### BRIEF DESCRIPTION OF THE DRAWINGS

Further features and advantages of the present subject matter will become apparent from the following detailed description, taken in combination with the appended drawings, in which:

FIG. 1 illustrates an exemplary environment of a device worn by a user, in accordance with one embodiment of present disclosure;

FIG. 2 illustrates an exploded view of the device;

FIG. 3 illustrates the device aligned with an adhesive strip, in accordance with one embodiment of the disclosure;

FIGS. 4A and 4B show a top perspective and a bottom perspective view, respectively of the device;

FIG. 5 illustrates a block diagram of the device;

FIG. 6 shows a method of applying vibration on a muscle during a workout for causing the user to think more about the muscle, in accordance with one embodiment of present disclosure;

FIGS. 7A through 8B illustrate the feature of user placing the device at one muscle group and then repositioning (reattaching) the device at another muscle group during a workout session; and

FIG. 9 shows a high-level block diagram of an exemplary network communications system in which a device for applying vibration on a muscle group for improving muscle contraction implements, in accordance with one exemplary embodiment of present disclosure.

It will be noted that throughout the appended drawings, like features are identified by like reference numerals.

### DETAILED DESCRIPTION OF THE EMBODIMENTS

Before the present features and working principle of a device for applying vibration on a muscle group for improving muscle contraction is described, it is to be understood that this subject matter is not limited to the particular system as described, since it may vary within the specification indicated. Various features for applying vibration on a muscle group for improving muscle contraction might be provided by introducing variations within the components/subcomponents disclosed herein. It is also to be understood that the terminology used in the description is for the purpose of describing the particular versions or embodiments only, and is not intended to limit the scope of the present subject matter, which will be limited only by the appended claims. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

It should be understood that the present subject matter describes a device and a method of applying vibration on a muscle or muscle group for improving muscle contraction during exercise. The device includes a motor. The device includes an adhesive strip. The adhesive strip removably mounts over a muscle. The motor causes vibration and transmits the vibration to the muscle through the device and the adhesive strip causing the user to concentrate on the muscle. The user detaches the device from one muscle and attaches to another muscle. The vibration caused by the motor helps the user to concentrate on the muscle during a workout and this helps to improve muscle contraction, thereby improving the mind-muscle connection.

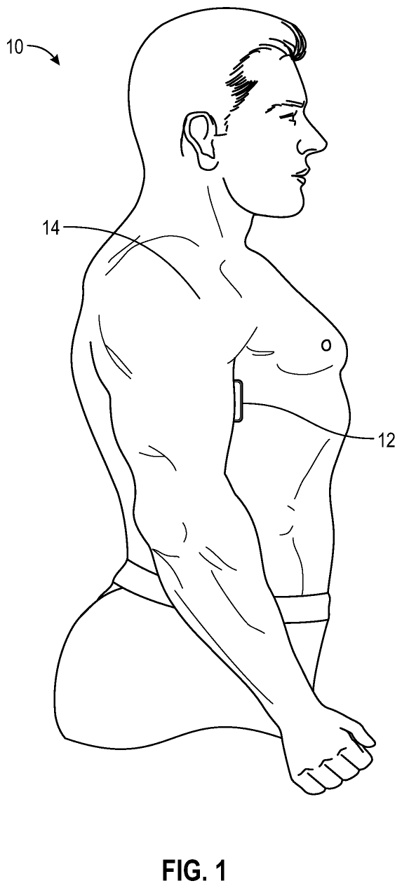

Various features and embodiments of the device for applying vibration on a muscle for improving muscle contraction are explained in conjunction with the description of FIGS. 1-9.

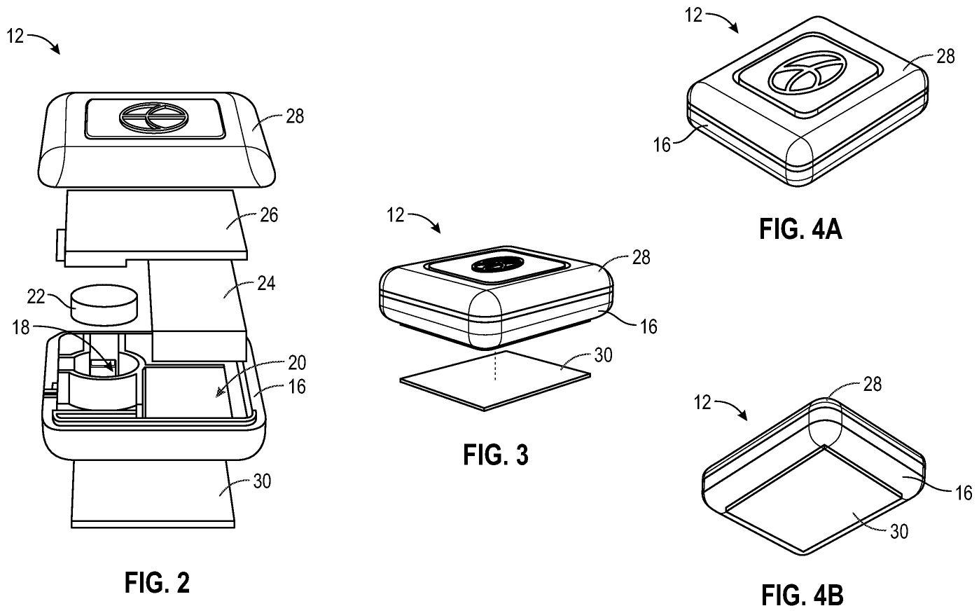

The present subject matter discloses a device for applying vibration on a muscle for improving muscle contraction. FIG. 1 shows an environment 10 of device 12 attached to user 14. FIG. 2 shows an exploded view of device 12, in accordance with one embodiment of the present disclosure. Device 12 includes base 16. Base 16 indicates a bottom plate or bottom part or bottom case of device 12. Base 16 provides a material made of hard plastic, metal or any other suitable material. Base 16 provides a rigid material capable of supporting the weight of components of device 12 and forces associated with the vibration (vibration of motor 22). Base 16 provides a material that is appropriately rigid and elastic to transmit the vibration effectively when mounted to user 14 (FIG. 1, for example). Base 16 encompasses first opening 18 and second opening 20. Base 16 comes in a square, rectangular or any other shape. In one example, first opening 18 presents a circular portion with suitable depth. A person skilled in the art understands that first opening 18 may come in any other shape. Further, second opening 20 presents a rectangular, square or any other shape, configuration with suitable depth.

First opening 18 receives motor 22. Here, motor 22 indicates a vibration motor having stator and windings. In one example, motor 22 encompasses an axle/shaft (not shown) with a mass (eccentric weight). The mass mounts to the axle off centre (asymmetric mass) such that the inertia of the spinning offset causes a wobble or vibration or oscillation in motor 22 and thereby in device 12. Device 12 includes battery 24 for powering motor 22. A person skilled in the art understands that battery 24 acts a power source for device 12. Battery 24 includes a replaceable or rechargeable battery. Battery 24 includes a lithium ion battery, for example. In the current embodiment, second opening 20 receives battery 24.

Device 12 encompasses printed circuit board (PCB) 26. Further, device 12 presents top case 28. Top case 28 indicates a top plate or top part. Top case 28 provides a material made of hard plastic, metal or any other suitable material. Top case 28 comes in a square, rectangular or any other shape similar to base 16. Top case 28 aligns with base 16 and encloses motor 22, battery 24 and PCB 26 as shown in FIGS. 3, 4A and 4B. In other words, base 16 and top case 28 form a mechanical housing for holding motor 22, battery 24 and PCB 26.

In one embodiment, device 12 includes an adhesive strip 30. Adhesive strip 30 comes in a variety of shapes including, but not limited to, square, rectangular, circular, oval or any other shape. In one example, adhesive strip 30 includes a reusable and dual-sided adhesive. Adhesive strip 30 aligns with base 16 (FIG. 3) and mounts to device 12 at the bottom of base 16. FIGS. 4A and 4B show a top perspective and a bottom perspective view, respectively of device 12. As can be seen from FIG. 4B, adhesive strip 30 mounts at the bottom of base 16. A person skilled in the art understands that one side of adhesive strip 30 attaches to base 16, and other side is exposed. The exposed side attaches to user 14 (FIG. 1). Adhesive strip 30 has suitable adhesion strength and sticks to user's body even when user 14 performs rigorous exercises. User 14 may have to use his or her strength to detach device 12 (adhesive strip 30) from one muscle group to attach it to another muscle group during a workout session or to store it when not in use. Adhesive strip 30 has suitable thickness such that it passes the vibrations caused and transmitted from motor 22 through base 16 to user's body when attached.

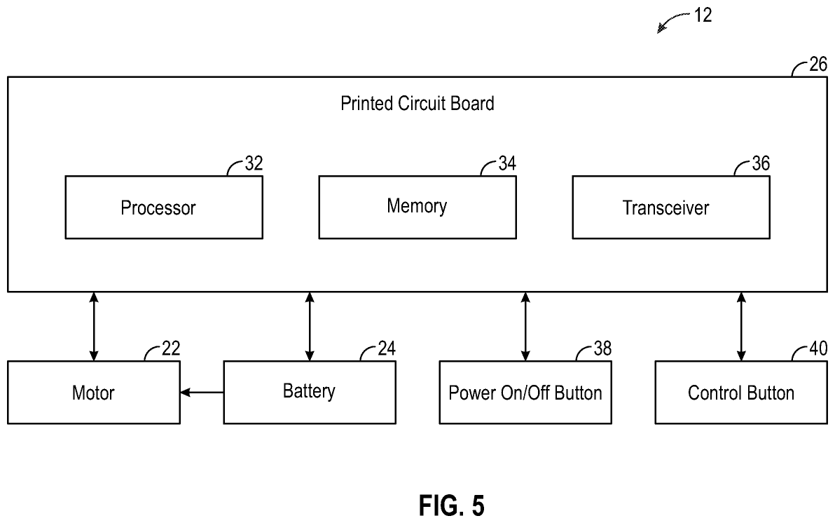

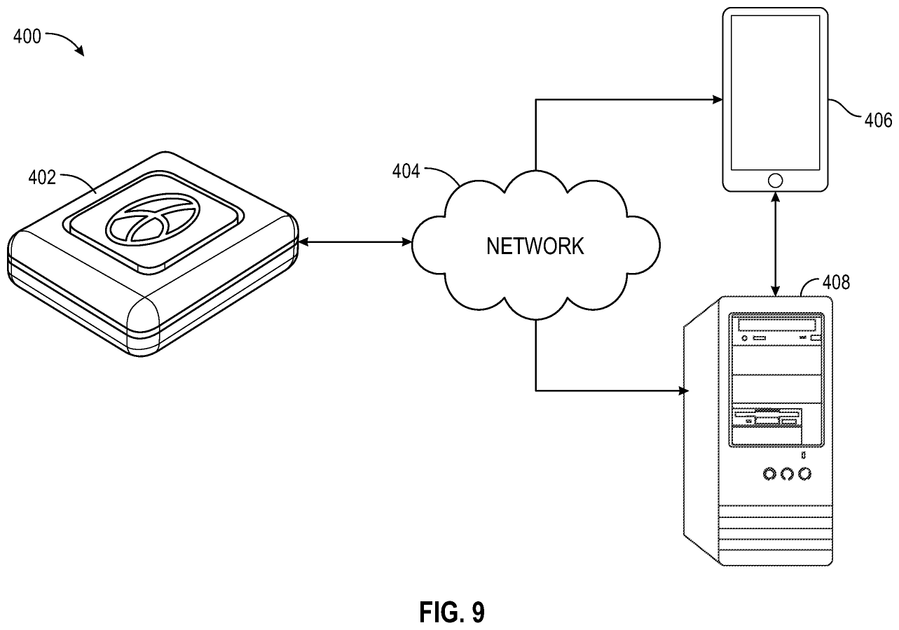

FIG. 5 shows a block diagram of device 12, in accordance with one embodiment of the present disclosure. As specified above, device 12 includes PCB 26. PCB 26 includes processor 32, memory 34 and transceiver 36. Processor 32 includes a microprocessor that runs a program stored in memory 34 to operate device 12. In one example, processor 32 puts device 12 in SLEEP mode and turns OFF motor 22 when not in use. This helps to put device 12 in standby or SLEEP mode and prolongs life of battery 24. Transceiver 36 configures to communicate with an external wireless transmitter (not shown), say a handheld device (FIG. 9). Further, PCB 26 electrically connects to power ON/OFF button 38 and control button 40. In one implementation, power ON/OFF button 38 and control button 40 mount at outer portion of device 12, at top case 28, for example. Battery 24 supplies power to PCB 26 and motor 22. Processor 32 reads a voltage from power ON/OFF button 38 and operates motor 22. In one implementation, control button 40 helps to control when motor 22 turns ON and OFF. In one example, control button 40 helps to set frequency of motor 22 for providing vibrations. The vibration frequency may be tuned in the range of 30-50 Hz, for example. However, the frequency disclosed herein should not be construed in a limited sense. The desired vibration frequency is tuned such that the vibration causes user 14 to think about a muscle more during a workout.

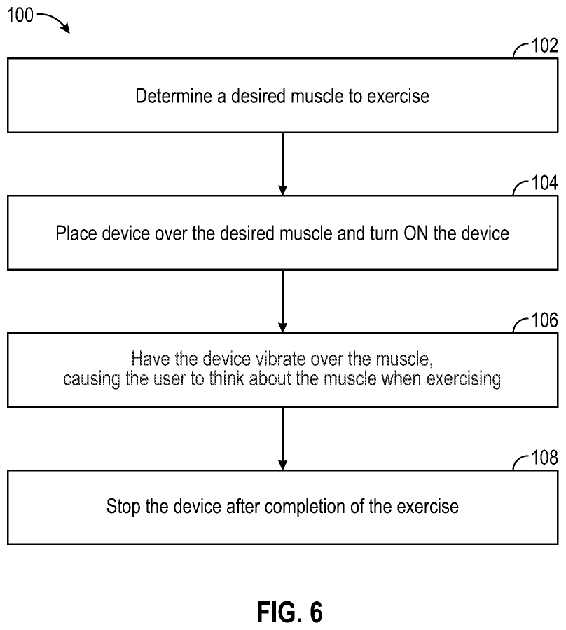

FIG. 6 shows a method 100 of applying vibration on a muscle group during a workout for causing user 14 to think more about the muscle, in accordance with one exemplary embodiment of the present disclosure. The order in which method 100 is described should not be construed as a limitation, and any number of the described method blocks can be combined in any order to implement method 100 or alternate methods. Additionally, individual blocks may be deleted from method 100 without departing from the spirit and scope of the disclosure described herein. However, for ease of explanation, in the embodiments described below, method 100 may be implemented using the above-described device 12.

At step 102, user 14 determines a muscle or muscle group (or even joints) to exercise. As known, muscle groups include, but are not limited to muscles in the chest, back, arms, shoulders, abs, legs, and buttocks. To use device 12 for applying a vibration on the muscle or muscle group the user 14 should think about the muscle during exercise and a vibration on the muscle makes it easier for the user to think about and concentrate on that particular muscle, therefore improving mind-muscle connection. The user 14 determines the muscle group (say abs) and mounts device 12 over the muscle group (abs). Here, user 14 aligns adhesive strip 30 over the muscle group and attaches device 12 using adhesive strip 30. In one example, user 14 places adhesive strip 30 over his or her skin. In another example, user 14 places adhesive strip 30 over his or her clothing. As specified above, adhesive strip 30 has suitable adhesion strength. As such, adhesive strip 30 ensures device 12 sticks to user's skin (abs in the current example). Upon placing and attaching device 12 over the desired muscle or muscle group, user 14 turns ON device 12 (step 104). In one example, user 14 operates power ON/OFF button 38 to turn ON device 12.

Once turned ON, processor 32 reads the voltage from power ON/OFF button 38 and operates motor 22. Motor 22 operates and causes vibrations. These vibrations transmit through base 16 and adhesive strip 30 to user 14. The vibration caused by device 12 at the muscle group (abs) causes user 14 to think more about the muscle group during the workout (step 106). This way, user 14 focuses his or her exercise on the muscle group where device 12 is placed. The vibration caused by device 12 is adjustable to provide subtle (minimum or reduced or controlled) vibration without distracting user 14 to keep adjusting device 12. After completing the workout/exercise, user 14 operates power ON/OFF button 38 to turn OFF device 12 (step 108). If user 14 wishes to repeat the exercise/workout, then user repeats steps 104, 106 and 108. Further, if user 14 wishes to exercise focusing on another muscle say triceps, then user 14 detaches device 12 from his or her abs and attaches to triceps. As specified above, adhesive strip 30 is reusable. As such, adhesive strip 30 retains its adhesion even after repeated use. After attaching device 12 to triceps, device 12 allows user 14 to perform method 100 as explained above. When attached to a particular muscle, device 12 vibrates on the particular muscle. The vibration causes user 14 to think about the muscle more, which helps in hypertrophy training for user 14. Focusing on one specific muscle may improve muscle contraction and provide required strength to the muscle.

In one advantageous feature of the present disclosure, adhesive strip 30 allows user 14 to easily remove device 12 from one muscle group and attach to another muscle group. Device 12 is portable and attaches to any muscle with the help of adhesive strip 30. This presents an advantage over known vibration devices, which mount with the help of straps. The straps present difficulty to mount to some places on the body. Whereas the presently disclosed device 12 allows for placing anywhere on the body and provides required vibration to user 14. A person skilled in the art understands that adhesive strip 30 takes minimum space required to attach device 12 to user's body and sticks to user's body until required force is exerted to detach it from user's body.

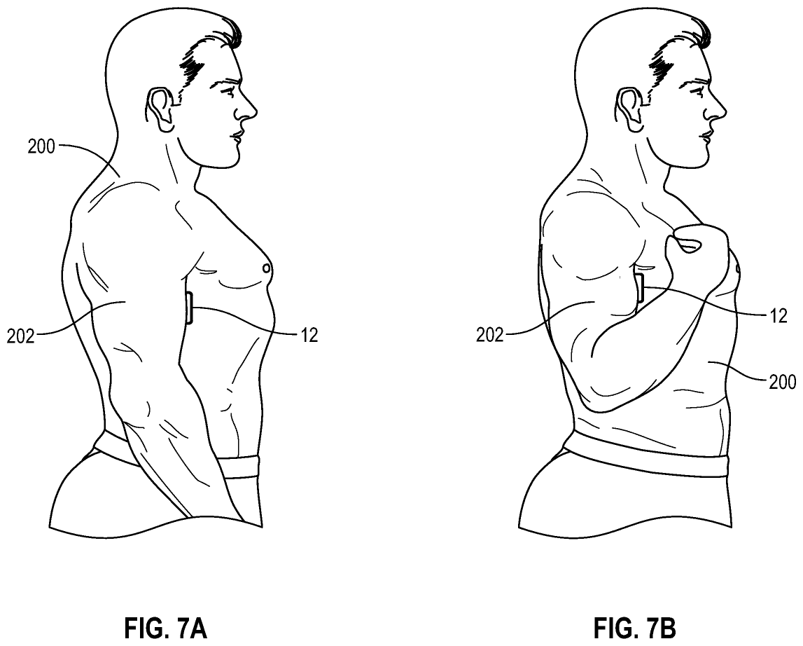

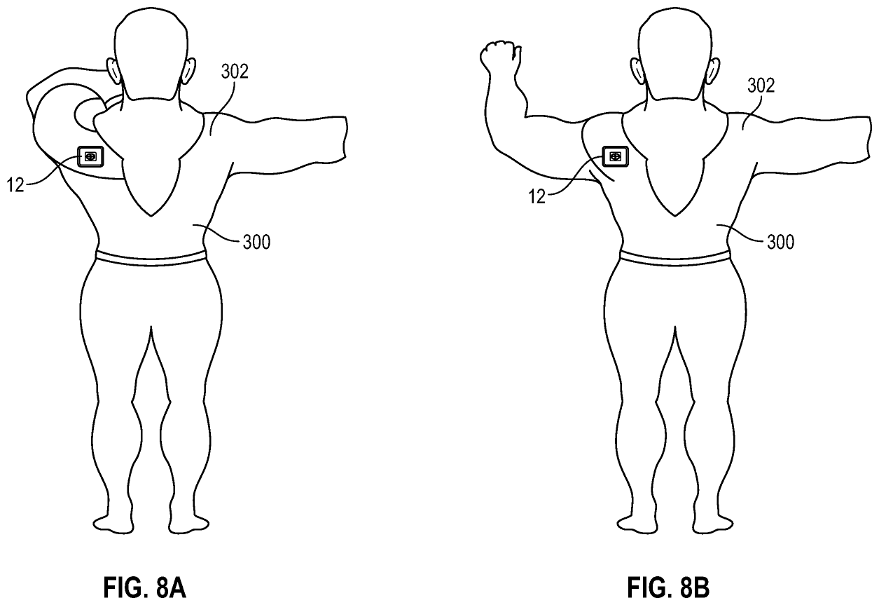

FIGS. 7A through 8B illustrate the feature of user placing the device at one muscle or muscle group, and then repositioning (reattaching) the device at another muscle or muscle group, in accordance with one exemplary embodiment of the present disclosure. FIGS. 7A and 7B show a feature of user 200 attaching device 12 over user's bicep 204 and exercising focusing on his or her bicep 204. Here, device 12 vibrates over bicep 204 and causes user 200 to think about the muscle (bicep 204) more during a workout. After completing the workout, user 200 detaches device 12. If needed, the user attaches the device over another muscle group. FIGS. 8A and 8B show a feature of user 300 attaching device 12 over the user's shoulders 304 and exercising focusing on the user's shoulders 304. Here, device 12 vibrates shoulders 304 and causes user 300 to think about the muscle(s) (e.g. muscles in the shoulder 304 region) more during a workout. After completing the workout, user 300 turns OFF device 12 and detaches it.

FIG. 9 shows a high-level block diagram of an exemplary network communications system 400, in accordance with one embodiment of the present disclosure. System 400 includes device 402 (similar to device 12). Device 402 communicatively connects to handheld device 406 and server 408 via network 404. Here, handheld device 406 indicates an electronic device such as a mobile phone, a tablet, a desktop computer, a smart watch, etc. Server 408 includes a database. Network 404 includes a wireless network, a wired network or a combination thereof. Network 404 can be implemented as one of the different types of networks, such as intranet, local area network (LAN), wide area network (WAN), the internet, Bluetooth, NFC and the like. In the current embodiment, handheld device 406 connects to device 402 via a transceiver (not shown, transceiver 36) present in device 402. Handheld device 406 configures the program stored in a memory of device 402. In one example, handheld device 406 configures or adjusts frequency at which a motor (motor 22) operates to cause vibration. In one example, handheld device 406 receives the duration of user's workout session from device 402. This helps the user to understand the duration and type of muscle he or she worked on. The user may use the information to focus on a particular muscle group and obtain a pattern to further improve muscle contraction and/or strength.

The presently disclosed device helps to increase muscle power, blood circulation and may reduce injury risk. The presently disclosed device is a portable device and allows for use in the gym, a race, during training, or exercising anywhere and anytime. The adhesive strip allows the device to easily attach and detach from one muscle group to another. As such, the user can quickly change the location of the device to the muscle group he or she wishes to strengthen and starts working out without any delay between exercises. The device helps the user to work on all major muscle groups and joints, including, but not limited to, quads, hamstrings, back, chest, abdominal muscles, arms, wrists, and shoulders.

A person skilled in the art appreciates that the device may come in a variety of shapes and sizes depending on the need of the user. Further, different materials in addition to or instead of materials described herein may also be used and such implementations may be construed to be within the scope of the present invention. Further, many changes in the design and placement of components may take place without deviating from the scope of the presently disclosed device and methods of using the device.

In the above description, numerous specific details are set forth such as examples of some embodiments, specific components, devices, methods, in order to provide a thorough understanding of embodiments of the present invention. It will be apparent to a person of ordinary skill in the art that these specific details need not be employed, and should not be construed to limit the scope of the invention.

In the development of any actual implementation, numerous implementation-specific decisions must be made to achieve the developer's specific goals, such as compliance with system-related and business-related constraints. Such a development effort might be complex and time-consuming, but may nevertheless be a routine under taking of design, fabrication, and manufacture for those of ordinary skill. Hence as various changes could be made in the above constructions without departing from the scope of the invention, it is intended that all matter contained in the above description or shown in the accompanying drawings shall be interpreted as illustrative and not in a limiting sense.

The foregoing description of embodiments is provided to enable any person skilled in the art to make and use the invention. Various modifications to these embodiments will be readily apparent to those skilled in the art, and the novel principles and invention disclosed herein may be applied to other embodiments without the use of the innovative faculty. It is contemplated that additional embodiments are within the spirit and true scope of the disclosed invention.

What is claimed is:

1. A method of applying vibration on a muscle or muscle group for improving muscle contraction, the method comprising:
providing a device having a motor;
providing an adhesive strip connecting to the device;
attaching the adhesive strip over a first muscle;
causing the motor to vibrate;
transmitting the vibration from the motor to the first muscle;
causing a user to concentrate on the first muscle due to the vibration for improving muscle contraction on the first muscle;
contracting the first muscle;
removing the device by detaching the adhesive strip of the device from the first muscle;
attaching the adhesive strip of the device over a second muscle;
causing the motor to vibrate;
transmitting the vibration from the motor to the second muscle; and,
causing the user to concentrate on the second muscle due to the vibration for improving muscle contraction on the second muscle.

2. The method of claim 1, wherein the first muscle and the second muscle comprises a group of muscles located in at least one of a user's chest, back, arms, shoulders, abs, legs, and buttocks.

3. The method of claim 1, further comprising adjusting the frequency of vibration caused by the motor to adjust the effect of vibration on the first muscle and the second muscle.

4. The method of claim 1, wherein the motor operates in a frequency in the range of 30-50 Hz.

5. A device for applying vibration on a muscle or muscle group for improving muscle contraction, the device comprising:
a base and a top case housing a motor; and,
an adhesive strip connecting the base;
wherein the adhesive strip removably mounts over a muscle, wherein the motor causes vibration and transmits the vibration to the muscle through the base and the adhesive strip, and wherein the vibration causes the user to concentrate on the muscle to improve muscle contraction during exercise.

6. The device of claim 5, further comprises a battery connecting the motor, wherein the battery powers the motor.

7. The device of claim 6, wherein the battery comprises a replaceable or rechargeable battery.

8. The device of claim 5, wherein the adhesive strip is a reusable dual-sided adhesive strip.

9. The device of claim 5, further comprising a handheld device communicatively connected to the device, wherein the handheld device configures the frequency of vibration caused by the motor to adjust the effect of vibration on the muscle.

10. The device of claim 5, wherein the muscle is located in at least one of a user's chest, back, arms, shoulders, abs, legs, and buttocks.

11. The device of claim 5, wherein the motor operates in a frequency in the range of 30-50 Hz.

12. The device of claim 5, wherein the base comprises an opening for receiving the motor.

13. The device of claim 6, wherein the base comprises an opening for receiving the battery.

14. The device of claim 5, wherein the device comprises a printed circuit board (PCB) for controlling the operation of the motor.

15. A method of applying vibration on a muscle or muscle group for improving muscle contraction, the method comprising:
determining a muscle of a user for exercising;
placing a device over the muscle using an adhesive strip, the device comprising a motor;
operating, by the processor, the motor for causing a vibration; and,
transmitting, by the motor, the vibration to the muscle, causing the user to concentrate on the muscle for improving muscle contraction during exercise.

16. The method of claim 15, further comprising adjusting, by the processor, a frequency of vibration caused by the motor to adjust the effect of vibration on the muscle.

17. The method of claim 15, wherein the muscle comprises a muscle located in at least one of a chest, back, arms, shoulders, abs, legs, and buttocks of a user.

18. The method of claim 17, wherein the muscle is a first muscle, and further comprising changing the placement of the device from the first muscle to a second muscle.

19. The method of claim 15, wherein the motor operates in a frequency in the range of 30-50 Hz.
